(19) United States
(12) Patent Application Publication
(10) Pub. No.: US 2024/0241531 A1
(43) Pub. Date: Jul. 18, 2024

(54) SUBSIDIARY INTERACTION OF CONTROLLERS

(71) Applicant: Barksdale, Inc., Los Angeles, CA (US)

(72) Inventor: Pascal CHOQUET, Oberursel (DE)

(21) Appl. No.: 18/617,733

(22) Filed: Mar. 27, 2024

Related U.S. Application Data
(63) Continuation of application No. 17/640,141, filed on Mar. 3, 2022, now Pat. No. 11,953,923.
(60) Provisional application No. 62/896,055, filed on Sep. 5, 2019.

(51) Int. Cl. G05D 23/19; G05B 15/02

(52) U.S. Cl. CPC G05D 23/1931; G05B 15/02; G05D 23/1935

(57) ABSTRACT

A decentralized control system with adjustable operations includes control devices for arrangement at a system for undertaking. When so arranged, the control devices determine a measurement of a control parameter at a respective one of the control devices, and electronically share the measurement with other one or ones of the control devices such that each of the control devices receive measurements from a different one or combination of the control devices. Upon receipt of an out-of-tolerance measurement from any other of the control devices, the respective one of the control devices adjusts its operational setpoint and/or sends a signal to a same and/or different other one or ones of the control devices to adjust their operational setpoint.

### CROSS-REFERENCE TO RELATED APPLICATIONS

This application is a continuation of US non-provisional application Ser. No. 17/640,141 filed Mar. 3, 2022, which is a national stage entry of PCT/US2020/049199 filed Sep. 3, 2020, which claims the benefit of US provisional application 62/896,055, filed Sep. 5, 2019; the disclosures of each of the foregoing are incorporated by reference as if fully restated herein.

### TECHNICAL FIELD

This invention relates to methods and systems of control devices arranged along a system under control, so that the individual control devices interact locally with at least one adjacent control device in a subsidiary manner, resulting in overall control of the system being maintained even if communication with a central control system fails. A particular embodiment covers temperature control along a pipeline.

### BACKGROUND OF THE ART

Many systems can operate with a single system parameter being controlled by a single control device. However, when many control devices are within control of a central control unit, often remotely located, effective control can be lost if there is any disruption of the communication between the central control unit and the dispersed controllers.

It is an unmet need of the prior art to provide a control system in which a principle of subsidiarity is used to gang together local groups of control devices to locally react to system disruptions.

### SUMMARY

These shortcomings of the prior art are overcome at least in part by a control arrangement for an operating system. The control arrangement comprises a plurality of control devices, arranged in the operating system in a sequential order, such that each control device shares information, comprising operational condition and a real-time measurement of at least one control parameter, with at least one control device in an upstream direction and at least one control device in a downstream direction.

In such a control arrangement, plurality of control devices further comprise a first and a second terminal control device. The first terminal control device is positioned at a beginning of the sequential order and the second terminal control device positioned at an end of the sequential order, such that the first terminal control device shares information only with control devices in the downstream direction and the second terminal control device shares information only with control devices in the upstream direction.

In some of the embodiments, each control device that is not a terminal control device shares information with at least two control devices in the upstream direction and at least two control devices in the downstream direction.

In some of any of these embodiments, the control devices are heating systems and the control parameter is temperature.

In such systems, each of the heating systems comprises a thermostat; a length of heat tracing line provided with electrical power through the thermostat; and a temperature sensor in contact with an object being heated by the length of heat tracing, the temperature sensor providing a feedback input to the thermostat.

### BRIEF DESCRIPTION OF THE DRAWINGS

A better understanding of the inventive concept will be had by reference to the appended drawings, wherein identical reference numbers identify identical parts and wherein:

FIG. 1A shows a system of control devices as known in the prior art, implemented on a pipeline under normal operation;

FIG. 1B shows a temperature versus distance diagram for the system of FIG. 1A;

FIG. 2A shows the system of control devices of FIG. 1A, wherein a disruption has occurred in a control device in the system;

FIG. 2B shows a temperature versus distance diagram for the system of FIG. 2A, as disrupted;

FIG. 3A shows a system of control devices incorporating the inventive concept under the same disruption as depicted in FIG. 2A; and

FIG. 3B shows a temperature versus distance diagram for the system of FIG. 3B, showing the effects of the subsidiary control protocol.

### DETAILED DESCRIPTION OF THE PREFERRED EMBODIMENTS

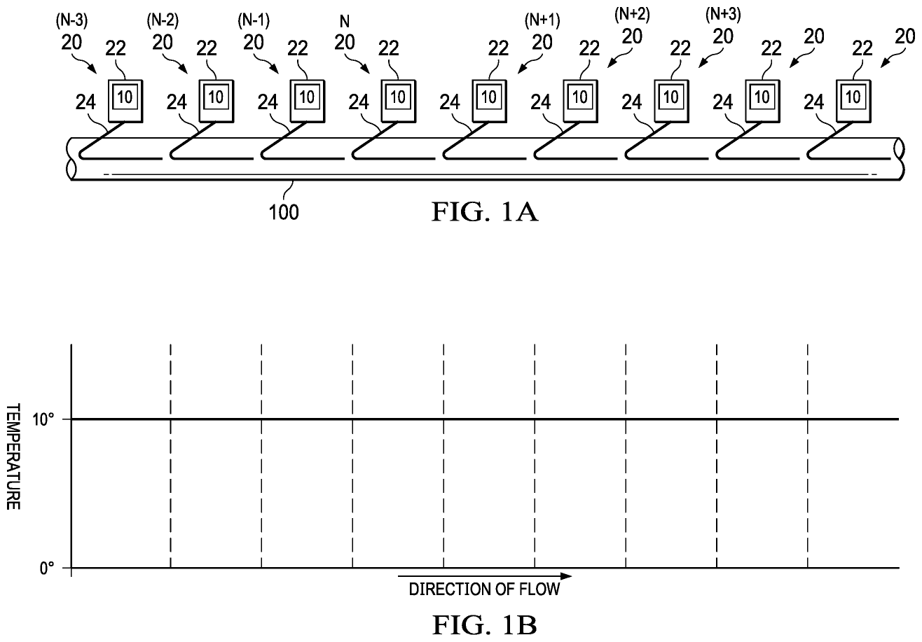

FIG. 1A schematically depicts a section of a pipeline 100. A plurality of heating systems 20 are arranged sequentially along the pipeline 100. Each heating system 20 has a thermostat 22 and a length of heat tracing line 24. In a hypothetical such as this, the systems 20 may be arranged at intervals of approximately 200 meters. A sensor 24 is in contact with the pipeline 100 and detects a temperature of the pipeline skin, which the sensor provides as an input signal to the thermostat 22, so that the power supplied to the heat tracing 24 may be controlled. In many of the systems of this type, power is applied to maintain a setpoint temperature. In the specific illustrative example, FIG. 1B shows how temperature varies with distance along the pipeline 100 when the system is operating ideally, with the setpoint at 10° C. In actual practice, the extremely flat horizontal slope of the temperature profile is not achieved, although the excursions are probably sufficiently minimal that they may be ignored. FIG. 1B also shows a baseline at 0° C., as this a freezing temperature for water. Operation as depicted in FIGS. 1A and 1B is trivial as long as each and every heating system 20 operates nominally. In FIGS. 1A, 2A and 3A, flow of the material in the pipeline 100 is from left to right, so seven of the heating systems 20 are numbered as (N−3), (N−2), (N−1), N, (N+1), (N+2) and (N+3) for purposes of illustration.

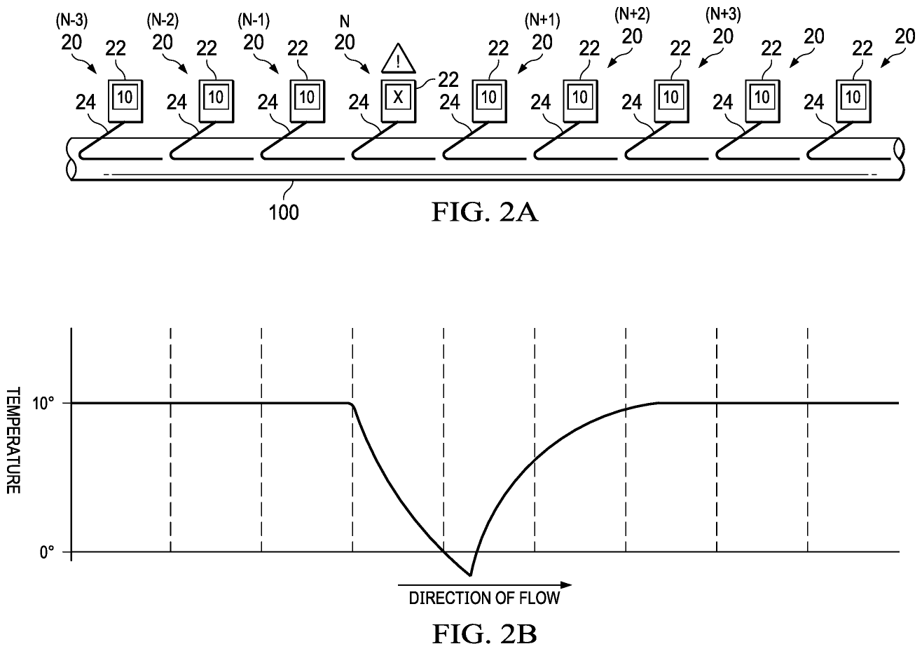

A complication can arise if one or more of the heating systems 20, in this case the heating system 20 numbered as N fails to maintain the setpoint temperature. This failure, illustrated in FIG. 2A, can occur from a variety of means, but assume it is due to a fault in the power line supplying the heat tracing 24. When this occurs, as depicted graphically in FIG. 2B. temperature in the pipeline segment controlled by heating system N drops. Since the heating systems denominated as (N−1) and (N+1), that is, the adjacent heating systems, are unaware of the fault. Depending on the circumstances, pipeline temperature could drop below 0° C. and adverse results could occur. As long as heating systems 20 denominated as (N+1) and up continue to function, recovery can occur, but it may take a long distance to restore the temperature to the setpoint.

One prior art solution (not illustrated) to avoid this problem is to connect each heating system with a central controller using a communication system (e.g. Modbus) to monitor and control it. Even this system can fail if a loss in signal, to or from the heating system, occurs.

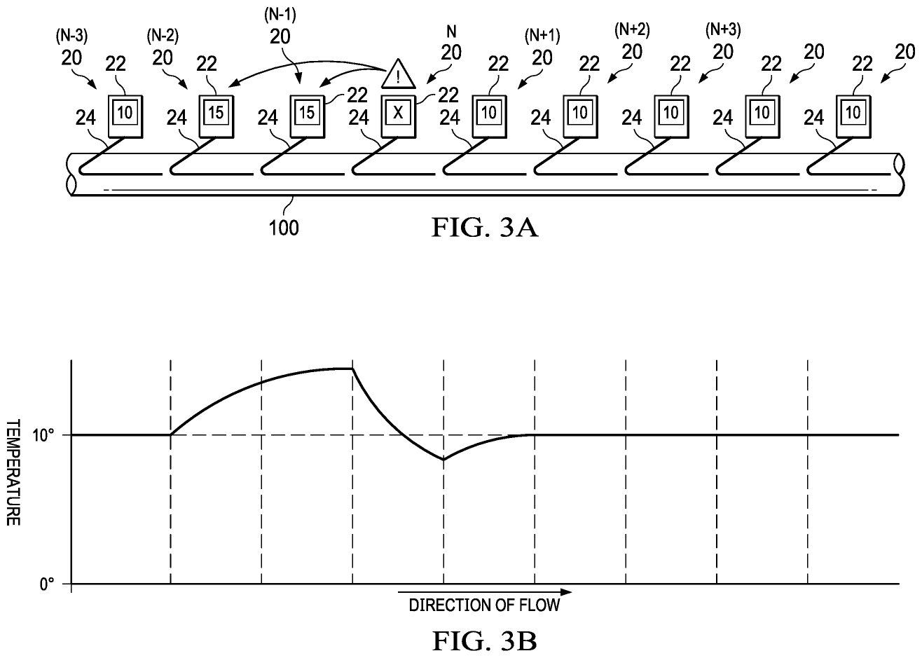

The inventive concept is seen in FIGS. 3A and 3B. As the temperature begins to drop in the zone of thermostat N, one of at least a few algorithms can be followed. In one of these algorithms, thermostat N receives a signal from its associated sensor and recognizes a decrease in temperature. This causes it to send a signal to at least the thermostat immediately upstream from it, that is, thermostat (N−1), that requires thermostat (N−1) to increase its setpoint by a predetermined amount. Thermostat (N−1) may also send a signal to thermostat (N−2) that requires it to increase its setpoint by a predetermined percentage of the setpoint increase that has occurred in thermostat (N−1).

In another variation of this algorithm, thermostat N, receiving a signal from its associated sensor, recognizes that the sensed temperature differs from the temperatures being sensed at the immediately adjacent temperature zones, that is, zones (N+1) and (N−1). If the difference exceeds a predetermined threshold, thermostat N sends a corrective signal in the appropriate direction. In this case, thermostat N instructs thermostat (N−1) to increase its setpoint by a predetermined amount. Thermostat (N−1) may in turn send a signal to thermostat (N−2) that requires it to increase its setpoint, based upon a comparison of the sensor signals from thermostats N and (N−2) using the same concept of comparing three spatially sequential temperatures signals, that is, the signals from thermostats (N−2), (N−1) and N.

The algorithm can extend to a situation where each thermostat in the system shares condition status information with each other thermostat. However, for practical purposes, the value of information from a remote thermostat declines significantly. For that reason, a practical limit may be to have every thermostat directly being informed by no more than four thermostats in the upstream direction and no more than four thermostats in the downstream direction. It is readily understood that the most remote of these thermostats will convey information indirectly through their connection to additional thermostats not in direct communication with the “central” thermostat in this regime.

A conventional thermostat receives a temperature signal and calculates a power output signal that is based on the temperature signal as converted to temperature and a set temperature. This system is operative regardless of whether the thermostat is a two point controller, a PID controller, a fuzzy controller, a neuro controller or another known type. When the inventive concept is applied, the additional information from additional thermostats in increasing distances upstream and downstream of the central or operating thermostat is received and appropriately discounted, based on distance (in terms of number of units) and direction (upstream or downstream). These data may be stored and used for tracking trends. This information can be usefully implemented in any of the types of controllers mentioned above.

As an example, thermostat N may operate in a standard manner if the condition data for thermostats N+1 and N+2 are unremarkable. However, if either thermostat N+1 or N+2 fails, by not reporting or indicating error, the set point in thermostat N may be raised by a predetermined amount. In another variation, if thermostat N+2 fails, the data from thermostat N+3, which might be otherwise ignored, is used in lieu of thermostat N+2. In either of these cases, thermostat N may append an indicator to its condition output signal, so that the adjacent thermostats will recognize that non-standard operation is occurring.

Of course, thermostat N may also send a signal to a remotely-located control point that it has noted a temperature difference that may indicate a malfunction in its zone of operation.

While the inventive concept is described as implemented on a system of sequentially-arranged thermostats to control temperature in a pipeline, it will be understood by one of skill in the art that the same concept may be used to maintain local control in the subsidiary manner by establishing communication between at least one adjacent control device and sharing information about at least one control parameter and the real-time condition of the control device. While temperature is a control parameter used illustratively here, many other control parameters could be used, including, for example, pressure, humidity, dissolved gas concentration and pH.

What is claimed is:

1. A decentralized control system with adjustable operations, said decentralized control system comprising:
control devices for arrangement at a system for undertaking operations, and when so arranged, configured to:
determine a measurement of a control parameter at a respective one of the control devices;
electronically share the measurement with other one or ones of the control devices such that each of the control devices receive measurements from a different one or combination of the control devices; and
upon receipt of an out-of-tolerance measurement from any other of the control devices at the respective one of the control devices, adjust an operational setpoint of said respective one of the control devices and/or send a signal to a same and/or different other one or ones of the control devices to adjust the operational setpoint of such one or ones of the control devices.

2. The decentralized control system of claim 1 wherein:
each of the control devices comprise a heating system or a pump; and
the measurement comprises a temperature or a pressure.

3. The decentralized control system of claim 2 wherein:
each of the control devices comprise the heating system;
the measurement comprises the temperature;
each of the heating systems comprises a thermostat, a length of heat tracing line provided with electrical power by way of the thermostat, and a temperature sensor in contact with an object of the system to be heated by the length of heat tracing line; and
the temperature sensor is electrically connected to the thermostat to a feedback input to the thermostat.

4. The decentralized control system of claim 1 wherein:
the control devices are configured for sequential arrangement at the system.

5. The decentralized control system of claim 4 wherein:
each of the control devices are located medially in the sequential arrangement;
each of the control devices are configured to receive the measurement from at least one of the control devices upstream of the respective one of the control devices in the sequential arrangement and at least one of the control devices downstream of the respective one of the control devices in the sequential arrangement.

6. The decentralized control system of claim 5 further comprising:
terminal control devices, wherein a first one of the terminal control devices is positioned at a beginning of the sequential arrangement and a second one of the terminal control devices positioned at an end of the sequential arrangement, and wherein the first one of the terminal control devices electronically shares information only with the control devices upstream in the sequential arrangement and the second one of the terminal control devices electronically shares information only with the control devices downstream in the sequential arrangement.

7. The decentralized control system of claim 6 wherein:
each of the control devices electronically shares information with at least four other of the control devices; and
each of the terminal control devices electronically shares information with at least two of the control devices.

8. The decentralized control system of claim 1 wherein:
each of the control devices is configured to determine the adjustment to the operational setpoint based, at least in part, on the out-of-tolerance measurement.

9. The decentralized control system of claim 1 wherein:
each of the control devices is configured to find the out-of-tolerance measurement where a value for the control parameter is received from the other one or ones of the control devices that is different from the measurement of the control parameter at the respective one of the control devices by at least a predetermined margin.

10. The decentralized control system of claim 1 wherein:
each of the control devices is configured to adjust an amount of energy applied by the respective one of the control devices to the system based, at least in part, on the measurement of the operational parameter at the respective one of the control devices relative to the operational setpoint of the respective one of the control devices.

11. The decentralized control system of claim 1 wherein:
the same and/or different other one or ones of the control devices comprises the control device from which the out-of-tolerance measurement originated.

12. The decentralized control system of claim 1 wherein:
the same and/or different other one or ones of the control devices comprises only different one or ones of the control devices from which the out-of-tolerance measurement originated.

13. The decentralized control system of claim 12 wherein:
the out-of-tolerance measurement comprises a lack of data signal for at least a predetermined period of time.

14. The decentralized control system of claim 12 wherein:
the out-of-tolerance measurement comprises an error message.

15. The decentralized control system of claim 1 wherein:
each of the control devices is configured to:
determine an operational status of itself; and
upon receipt of a non-functionality indication from any other of the control devices at the respective one of the control devices, adjust the operational setpoint of said respective one of the control devices and/or send the signal to the same and/or different other one or ones of the control devices to adjust the operational setpoint of the other one or ones of the control devices

16. The decentralized control system of claim 1 wherein:
each of the control devices are configured to determine the measurement in real-time.

17. The decentralized control system of claim 1 wherein:
each of the control devices is configured to adjust the operational setpoint of said respective one of the control devices a predetermined amount and send the signal to the same and/or different other one or ones of the control devices to adjust the operational setpoint of the same and/or different other one or ones of the control devices by at least a percentage of the predetermined amount.

18. The decentralized control system of claim 1 further comprising:
a central control device in electronic communication, at least indirectly, with the control devices and configured to issue operational signals to some or all of the control devices.

19. The decentralized control system of claim 1 wherein:
one of the control devices is designated as a central or operating control device which is in electronic communication, at least indirectly, with the control devices and configured to issue operational signals to some or all of the control devices.

20. A decentralized control system with adjustable operations, said decentralized control system comprising:
control devices arranged sequentially at a system undertaking operations, each comprising a sensor and an energy application element, wherein each of the control devices is configured to:
determine a measurement of a control parameter at a respective one of the control devices based, at least in part, on data received from the sensor of the respective one of the control devices;
apply a particular level of energy or refrain from applying the energy to the system by way of the energy application element of the respective one of the control devices based, at least on part, on the measurement relative to an operational setpoint of the respective one of the control devices;
electronically transmit the measurement to at least two other ones of the control devices in the sequential arrangement such that each of the control devices receive measurements of the control parameter from a different combination of the control devices; and
upon receipt of an out-of-tolerance measurement from any other of the control devices at the respective one of the control devices, adjust the operational setpoint of said respective one of the control devices and/or send a signal to a same and/or different other one or ones of the control devices to adjust the operational setpoint of such one or ones of the control devices.

21. A method of providing decentralized control and adjustable operations for a system, said method comprising:
determining a measurement of a control parameter at a respective one of a plurality of control devices arranged sequentially at a system undertaking operations, where each of the control devices comprises a sensor and an energy application element, where the measurement is determined based, at least in part, on data received from the sensor of the respective one of the control devices;
applying a particular level of energy or refraining from applying the energy to the system by way of the energy application element of the respective one of the control devices based, at least on part, on the measurement relative to an operational setpoint of the respective one of the control devices;
electronically transmitting the measurement to other one or ones of the control devices in the sequential arrangement such that each of the control devices receive measurements of the control parameter from a different one or combination of the control devices; and
receiving of an out-of-tolerance measurement from a same or different other one the control devices at the respective one of the control devices, and in response, perform one or both of:
adjusting the operational setpoint of said respective one of the control devices; and
electronically transmitting a signal to a same and/or different other one or ones of the control devices to adjust the operational setpoint of such one or ones of the control devices.
